(19) United States
(12) Patent Application Publication
(10) Pub. No.: US 2008/0179254 A1
(43) Pub. Date: Jul. 31, 2008

(54) Porous ceramics

(76) Inventors: Frederick J. Kauppi, Newport Beach, CA (US); James H. Welsh, Santa Ana, CA (US); Stephen R. Lyon, Long Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/698,593

(22) Filed: Jan. 26, 2007

(51) Int. Cl. C02F 1/42

(52) U.S. Cl. 210/670; 210/681; 210/287

(57) ABSTRACT

The present invention includes a porous ceramic material for use in removing aqueous contaminants from water. The ceramic material is formed by drying particular types of clay-water mixtures from air dry to 600° C. The clay is then calcined at between 700° C. and 1175° C. Finally, the clay is processed to a size larger than colloidal. The present invention also includes a system for removing pollutants from water consisting of a container filled with the porous ceramic material. The container may be serially connected to other containers and may be disposed on a trailer for portability. The present invention further includes a method of removing pollutants from water consisting of directing the contaminated water though a system containing the porous ceramic material. The porous ceramic material may be regenerated for further use by directing an acidic solution over the porous ceramic material.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to removing pollutants from water. In particular, the invention relates to the use of porous ceramic materials for removing pollutants from water including, but not limited to, heavy metals, metalloids, and orthophosphates, which for the purpose of this application shall be referred to as aqueous contaminants (AC).

2. Description of the Related Art

Clays have an ability (through cation exchange) to attract heavy metals as well as other pollutants. Examples of this are the contaminated sediments in many harbors throughout the world. These clays are colloidal and can go back into solution if mechanically disturbed. This situation makes dredging very difficult, if not impossible if water quality is an issue.

The main problem in using clays is the colloidal nature of the material itself. Clay particles have negatively charged sites that hold positively charged ions (cations) on their surfaces. The finer the clay is the higher the Cation Exchange Capacity (CEC), that is, the amount of cations that can be retained. This is true for most clays and varies with the amount of weathering the parent material has undergone. For example, Montmorillonite clay has a higher CEC than Illite clay. Montmorillonites can absorb heavy metals via two different mechanisms. In the first mechanism, there is cation exchange in the interlayers resulting from the interactions between ions and a permanent negative charge. In the second mechanism, there is formation of inter-sphere complexes through silicon oxide and aluminum oxide groups of the clay particle edges.

The adsorption potential of clay (specifically Montmorillonite) is somewhat dependent on the pH of the system as well as the presence of ligands (e.g., organic acids such as nitrilotriacetic acid, oxalic acid, tartaric acid, citric acid, etc.). These two factors have an effect on the AC removal efficiency of Montmorillonite. Also, temperature as well as the concentration of inflow metallic ions have an effect on adsorption/removal properties of the clay system.

Clay-based removal systems are simple, inexpensive methods to treat waters contaminated with AC. Although the method is simple, the chemical-thermodynamic-electromagnetic reactions are very complex. Generally, the adsorption of AC on clay is a function of the CEC. This property acts in concert with other reactions to influence the adsorption of AC.

Aqueous contaminants (AC) adsorbed on Montmorillonite can be readily stripped with acid solutions and reused multiple times. Finally, when the clay materials are released into the environment, there is little potential of secondary pollution. Besides acid stripping, there are proprietary products on the market which use electromagnetic processes to obtain similar results.

Clay-based systems work well for AC removal in wastewater settings. The drawback is the settling time required for the colloidal clays. Generally, the clays attract AC and are settled out of solution by gravity, coagulating agents (e.g., ALUM), electro-static forces, or some other means. The use of clay in water treatment has always had difficulty keeping the settled clays from re-mixing with the treated water. This makes it difficult to treat a continuous stream flow. Typically, some type of storage facility is required to facilitate the settling requirements.

Generally, clay-based systems are a cost effective method of treating AC contaminated wastewater. The limitations of such systems are primarily physically based (i.e., setting ponds, clay disposal, mixing devices, etc.). Clay-based systems all react in a similar manner by binding AC to the clay. The difference between systems is the efficiency at which they operate. The efficiency is dependent on many factors and is very complex. These factors include at least the type of raw clay used, the grain size, any mineral impurities, the pH of the system, the presence of ligands, and the type of pollutants present in the water.

Because of the large variety of factors involved, it is difficult to quantify the precise reactions undergone in clay-based systems. All clays react differently and even two samples from the same mine will usually have variations in their chemical compositions. Even though clays may vary greatly, there are still certain types that are similar and will react in a predictable manner. It is this property that allows the reactions to be generally quantified.

U.S. Pat. No. 6,413,432 issued to Kumaoka on Jul. 2, 2002 describes a method for treating water by the use of porous ceramics having amorphous pore surfaces. The type of clay used by Kumaoka is not disclosed. Furthermore, there is no discussion of using a clay with a naturally high CEC in order to remove heavy metal ions from the water at a much improved rate. Additionally, the clay in the Kumaoka process is dried at a temperature range between 600° C. and 800° C. and then baked at 1200° C. to 1500° C. At this high of a temperature, sintering (i.e., the fusion of fine particles to a glass-like state) of Montmorillonite clay would occur, thereby leading to a significant decrease in CEC and accordingly a significant decrease in the ability to remove heavy metal ions from water.

### BRIEF SUMMARY

The current invention envisions converting clay to a ceramic prior to any treatment taking place in order to overcome the difficulties encountered when using clay. This conversion will create a high crystalline rigid structure that will be stable in a water environment and not physically break down. It can be used as a filter media with the ability to reprocess the media and recycle under certain conditions.

The clay is calcined into a ceramic matrix having a particle size that exceeds the size of a colloidal particle. The range of particle sizes envisioned by the present invention ranges from a fine sand to a small gravel. By having particles sized as such, the settling velocities will be high and therefore remove the need for setting ponds as is typical within the prior art. The porous ceramic will therefore be able to act as a stationary filter media, removing AC from water, and will be capable of treating water via a continuous stream of water. Prior art processes would have the clay suspended in the water, necessitating long settling times in engineered basins.

In order to achieve this porous ceramic matrix the clays are fired at a temperature near the bottom range of the calcination process. As the temperature is increased the calcined clay will begin the sintering process, that is, the fired clay will transform from a porous ceramic to a glass-like structure. Sintered clay gains strength and stability, however, at the cost of a loss in Cation Exchange Capacity (CEC). This loss in CEC will cause a decrease in the ceramic's ability to sequester heavy metal ions, as occurs in the prior art processes.

The porous ceramic of the present invention is achieved by using a raw clay which has a naturally high CEC. A porous ceramic is formed from this raw clay by calcining at a low temperature, thereby maintaining a high level of CEC while also increasing the structural strength of the clay. The porous ceramic thus formed is then processed into a settleable grain size for use in the treatment of water. Prior to the calcining of the clay, other mineral additives may be optionally added to the clay in order to increase the efficiency of the metal removal. Exemplary of a mineral additive to be added is iron oxide.

Another embodiment of the present invention contemplates a system for removing pollutants from water. The system includes at least one container filled with the porous ceramic material described above. Yet another embodiment of the present invention contemplates a method of removing pollutants from water wherein contaminated water is directed through a system containing the porous ceramic material described above.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a series of pipes filled with the porous ceramic of the present invention; and

FIG. 2 is an exploded view of a portable unit consisting of the series of pipes shown in FIG. 1 and a trailer unit.

### DETAILED DESCRIPTION

One embodiment of the present invention envisions a porous ceramic material for use in removing pollutants from water. The ceramic material is formed by first drying a high-Cation Exchange Capacity (CEC) clay-water mixture at a low temperature that could vary from air drying at room temperature (i.e., about 20° C.) to about 600° C. Preferably the clay-water mixture is dried at a temperature between 100° C. to 600° C. During this drying stage, water is removed from the clay resulting in an overall volume reduction. Next, the clay is calcined at a temperature between about 700° C. to about 1175° C. Finally, the calcined clay is processed to a larger than colloidal size. The drying and calcining processes may be accomplished by any method known within the art, including firing the clay within a kiln. By drying and calcining the clay, a ceramic matrix is formed thereby causing an increase in the strength and stability of the clay. However, by using the relatively low temperatures described in this invention a larger proportion of CEC is retained by the clay than if higher temperatures associated with sintering had been used.

A specific clay that is known to have a high-CEC and therefore is a preferred clay for use in the present invention is Montmorillonite clay. In order to maximize the surface area of the ceramic material, the calcined clay may be processed into a pellet form. Preferably, the pellets will be similar in size to sand or gravel, i.e., between about 0.0625 millimeters in diameter and about 64 millimeters in diameter. Alternatively, the clay may be formed into bricks and subsequently crushed and screened to the desired size.

In order to further increase the efficiency of metal removal, other mineral additives may be added to the clay prior to calcining. Particularly suitable additives for this purpose include iron oxides.

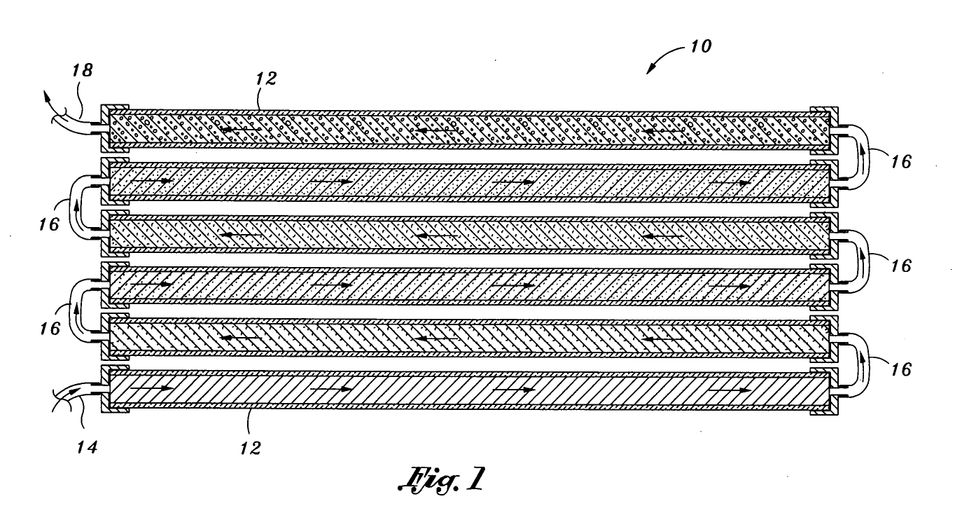

Another embodiment of the present invention contemplates a system 10 for removing pollutants from water. The system 10 is made up of a container 12 filled with a porous ceramic material. The container 12 has a first means 14 for allowing the entrance of polluted water to the container and a second means 18 for allowing the exit of decontaminated water from the container 12. The porous ceramic material is formed by the process described above. In particular a high-CEC clay-water mixture is dried at a temperature between room temperature to about 600° C. The clay is then calcined at a temperature between about 700° C. to about 1175° C. And finally, the calcined clay is processed to a size larger than colloidal clay. A preferred system is shown in FIG. 1, wherein the container 12 is tube-shaped. The tube 12 is filled with the porous ceramic material and has an inlet 14 for receiving the polluted water connected to one end of the tube 12. The tube 12 also has an outlet 18 for expelling the treated water connected to the opposite end of the tube 12.

The tube 12 may be connected in series to at least one other tube 12, as is shown in FIG. 1. The tubes 12 are attached from the outlet 18 of one tube 12 to the inlet 14 of another tube by a connector 16.

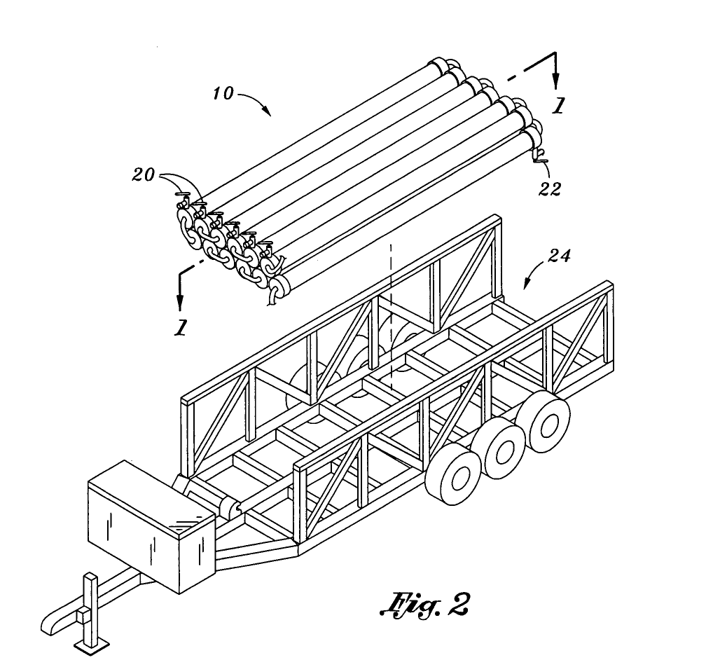

As shown in FIG. 2, the system 10 can be made portable by attaching the plurality of tubes 12 to a trailer unit 24. The system 10 may therefore be towed to a location by a typical pickup truck, thereby facilitating the decontamination of water in areas that may not otherwise be conducive to large scale decontamination. Additionally, valves, such as gate-valves, may be attached to each tube 12. In particular, a first valve 20 may be positioned at the top front of a tube 12. Also, a second valve 22 may be positioned at the bottom rear of a tube 12. A system 10 including such valves may be caused to canter, such that the first valves 20 are elevated and the second valves 22 are lowered. When positioned in such a manner, the first valves 20 may be opened in order to purge air from the tubes 12. The air will rise within the tubes 12 and exit via the first valves 20. It is believed that tubes 12 purged of air, so that the tubes 12 only contain the ceramic material and water, will perform optimally. Once purification has been completed, the second valves 22 may be opened in order to dump any remaining water that may remain within the tubes 12. If necessary, multiple systems can be connected either in parallel or in series to facilitate decontamination of particularly large or polluted bodies of water. Additionally, portable Sub-Surface Flow Constructed Wetlands have been devised that allow for the removal of pollutants from bodies of water. In order to achieve an even greater reduction in pollutants, the system 10 of the present invention may be serially connected to such a portable Sub-Surface Flow Constructed Wetland unit.

Another embodiment of the present invention contemplates a method of removing pollutants from water. In this method the polluted water is directed through a container containing a porous ceramic material. As described above, the porous ceramic material is formed by first drying a high-CEC clay-water mixture at a temperature between room temperature to about 600° C. Next, the clay is calcined at a temperature between about 700° C. to about 1175° C. Finally, the calcined clay is processed so as to be larger than colloidal size. The water may optionally be directed though a series of containers containing the porous ceramic material.

The porous material described in the present invention, whether used alone, in the described system or in the described method may be regenerated for further use. When the ceramic material has reached its binding capacity and no longer is able to remove pollutants from the water the material may be flushed with an acidic solution to remove the pollutants. This may be followed by a saltwater rinse to replace the ions lost in the CEC reaction, thereby regenerating the material for further use. The contaminants may thereby be disposed of and the ceramic material may be used for further decontamination.

The above description is given by way of example, and not limitation. Given the above disclosure, one skilled in the art could devise variations that are within the scope and spirit of the invention disclosed herein, including various ways of forming the container that holds the porous ceramic material within the system. For example, the container could be formed as a typical filter cartridge as is commonly used in swimming pools and/or storm drainage catch basins. This type of container would be beneficial in situations where there is a low-level of contaminants that is continuously or intermittently being introduced to a body of water or storm drainage system. Whereas the tube system would be more useful in situations requiring a one-time or non-continuous decontamination of a body of water. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A porous ceramic material for use in removing pollutants from water, said material formed by:
drying a high-CEC clay-water mixture at a temperature between about 20° C. to about 600° C.;
calcining the clay at a temperature between about 700° C. to about 1175° C.; and
processing the calcined clay to a larger than colloidal size.

2. The porous ceramic material of claim 1, wherein the high-CEC clay is Montmorillonite.

3. The porous ceramic material of claim 1, wherein the drying is performed between about 100° C. to about 600° C.

4. The porous ceramic material of claim 1, wherein the calcined clay is processed into a pellet form.

5. The porous ceramic material of claim 4, wherein the pellets are between 0.0625 millimeters and 64 millimeters in diameter.

6. The porous ceramic material of claim 1, wherein prior to calcining the clay at least one mineral additive is added to the clay.

7. The porous ceramic material of claim 6, wherein the mineral additive is an iron oxide.

8. A system for removing pollutants from water, the system comprising:
a. a porous ceramic material, said material formed by:
i. drying a high-CEC clay-water mixture at a temperature between about 20° C. to about 600° C.;
ii. calcining the clay at a temperature between about 700° C. to about 1175° C.; and
iii. processing the calcined clay to a larger than colloidal size;
b. a container filled with said porous ceramic material;
c. a first means for allowing the entrance of polluted water to the container; and
d. a second means for allowing the exit of decontaminated water from the container.

9. The system of claim 8, wherein the container is a tube.

10. The system of claim 9, wherein the first means is an inlet connected to one end of the tube and the second means in an outlet connected to the opposite end of the tube.

11. The system of claim 10, wherein at least two tubes are connected in series by connecting the inlet of one tube to the outlet of another tube.

12. The system of claim 11, wherein a plurality of serially connected tubes are disposed on a trailer unit.

13. A method of removing pollutants from water, the method comprising directing the polluted water through a container containing a porous ceramic material, wherein the porous ceramic material is formed by:
drying a high-CEC clay-water mixture at a temperature between about 20° C. to about 600° C.;
calcining the clay at a temperature between about 700° C. to about 1175° C.; and
processing the calcined clay to a larger than colloidal size.

14. The method of claim 13, wherein the water is directed through a series of containers containing the porous ceramic material.

15. The method of claim 13 further comprising directing an acidic solution through the container.

16. The method of claim 15 further comprising directing a saltwater rinse through the container.
